(19) United States
(12) Patent Application Publication
(10) Pub. No.: US 2016/0266508 A1
(43) Pub. Date: Sep. 15, 2016

(54) TWO-COMPONENT DEVELOPER

(71) Applicant: Konica Minolta, Inc., Tokyo (JP)

(72) Inventors: Shinya OBARA, Tokyo (JP); Satoshi UCHINO, Tokyo (JP); Kosuke NAKAMURA, Tokyo (JP)

(21) Appl. No.: 15/060,039

(22) Filed: Mar. 3, 2016

(30) Foreign Application Priority Data
Mar. 10, 2015 (JP) 2015-047364

(51) Int. Cl. G03G 9/08

(52) U.S. Cl. CPC G03G 9/0819; G03G 9/0827

(57) ABSTRACT

A two-component developer of the present invention contains toner particles and carrier particles. The number-average particle diameter of the toner particles ranges from 3.5 to 5.0 μm. The volume-average particle diameter of the carrier particles MDc is within a specific range in accordance with the percentage of relatively large toner particles having relatively low circularity.

### CROSS REFERENCE TO RELATED APPLICATIONS

This application is entitled to and claims the benefit of Japanese Patent Application No. 2015-047364, filed on Mar. 10, 2015, the disclosure of which including the specification, drawings and abstract is incorporated herein by reference in its entirety.

### BACKGROUND OF THE INVENTION

1. Field of the Invention

The present invention relates to two-component developers for developing electrostatic latent images.

2. Description of Related Art

Formation of color images by the electrophotographic process generally involves the use of two-component developers that contain toner particles containing a colorant, and carrier particles for stirring and conveying the toner particles. With the spread of digital printing, for example, high-quality images and stable image formation have been increasingly required. To that end, methods have been studied from the viewpoint of energy saving, e.g., lowering the melt temperature or melt viscosity of the binder resin composing toner particles for reduced energy required for the fixation of toner images on paper, reducing the amount of toner particles on paper for reduced energy required for the fixation of toner images, and so forth.

As for the latter method (i.e., reducing the amount of toner particles on paper), it has been considered to reduce the particle diameter of toner particles. By making toner particles smaller, the surface area of the toner particles is increased, and thus it becomes possible to cover paper (i.e., form an image) with a less amount of toner particles. As a result, it becomes possible to reduce energy required for the fixation without lowering image density. Further, smaller toner particles can well reproduce fine latent images, and thus achievement of both energy saving and formation of high-quality images is expected.

As for the toner particles with small particle diameter, two-component developers containing the toner particles having small particle diameter and high circularity, and substantially spherical carrier particles having a predetermined component ratio and specified average particle diameter are known (e.g., refer to Japanese Patent Application Laid-Open No. 2005-321725).

However, when toner particles are made smaller, the number of contact points between the toner particles and carrier particles is increased. Therefore, the flow ability of the two-component developer becomes insufficient, and the toner particles attach to the carrier particles to cause toner-spent to easily occur, which stains the surface of the carrier particles. As a result, problems occur, such as uneven electric charge amount of toner particles, uneven conveyance amount of toner particles by carrier particles during developing, and uneven magnetic brush formation of the carrier particles. These problems may make stable formation of high-quality images difficult.

The two-component developers disclosed in Japanese Patent Application Laid-Open No. 2005-321725 leave room for consideration of the toner-spent problem caused by downsizing toner particles.

### SUMMARY OF THE INVENTION

An object of the present invention is to provide a two-component developer capable of maintaining high flow ability and of suppressing the occurrence of toner-spent even when smaller toner particles are used.

As one aspect for achieving the above-mentioned object, the present invention provides a two-component developer for developing an electrostatic latent image, containing toner particles and carrier particles, in which a number-average particle diameter of the toner particles ranges from 3.5 to 5.0 μm, and in which the two-component developer satisfies the following Formula 1:

−X/8+24.75≦MDc≦−X/8+35.25 Formula 1

where “MDc” represents a volume-average particle diameter (μm) of the carrier particles, and “X” represents a proportion (%) of toner particles having a number distribution-based particle diameter of 4.5 μm or more to less than 10.0 μm and a circularity of 0.940 or less in the total of the toner particles, with the proviso that 10≦X≦50 in Formula 1.

### BRIEF DESCRIPTION OF DRAWINGS

The present invention will become more fully understood from the detailed description given hereinbelow and the appended drawings which are given by way of illustration only, and thus are not intended as a definition of the limits of the present invention, and wherein:

FIG. 1 schematically illustrates a configuration of an example of an image forming apparatus in which a two-component developer according to an embodiment of the present invention is used.

### DESCRIPTION OF THE PREFERRED EMBODIMENTS

It is effective to further increase the average circularity of toner particles in a two-component developer, from the viewpoint of increasing the flow ability of the two-component developer. However, relatively small toner particles having high average circularity contact or collide with carrier particles highly frequently during mixing with the carrier particles due to their small diameter and high circularity, which is likely to cause toner-spent. Further, when the toner particle is made larger, the flow ability of the two-component developer is secured even with low circularity, but may cause the lowering of image quality compared to the case of using toner particles with smaller diameter.

In addition, when the particle diameter of carrier particles is increased, the flow ability of the two-component developer is enhanced, but the collision force of the carrier particles with toner particles becomes strong, resulting in cracks or chips in the toner particles, which may cause toner-spent. As a result, the flow ability of the two-component developer is undesirably lowered, causing uneven magnetic brush formation on a developing sleeve or uneven electric charge amount, which may lead to the lowering of image quality.

In view of the foregoing, in using toner particles with small particle diameter, the present invention allows carrier particles having a proper particle diameter to be combined with toner particles with small diameter, depending on the percentage of toner particles in a specific range where the particle diameter is relatively large and the circularity is relatively low in the toner particles. Thus, it becomes possible to achieve the enhancement of stability of the two-component developer, as well as the stable output of high-quality images.

Embodiments of the present invention will now be described.

The two-component developer according to the present embodiment is a two-component developer for developing an electrostatic latent image, and contains toner particles and carrier particles. It is noted that the toner particles have, for example, toner base particles and an external additive adhered to the surface thereof, and the toner base particle is, for example, a particle which is composed of a binder resin and which may contain a colorant and other additives.

The two-component developer can be produced in a manner similar to that for typical two-component developers except that toner particles and carrier particles described below are used. For example, the two-component developer can be produced by appropriately mixing the toner particles and carrier particles such that the toner particle content (toner concentration) in the two-component developer is 4.0 to 8.0 mass %.

The number-average particle diameter of the toner particles MDt ranges from 3.5 to 5.0 μm. When MDt is less than 3.5 μm, the flow ability of the toner particles in the two-component developer may be lowered; for example, mixing of the toner particles and the carrier particles during continuous printing becomes insufficient, which may result in insufficient image quality (e.g., poor in terms of grainy feeling of an image) due to uneven electric charge of the toner particles. When MDt is more than 5.0 μm, for example, image fineness may become insufficient, resulting in insufficient image quality.

MDt is a number-average particle diameter of toner particles, and may be either a median diameter (D50t) or a mode diameter, when the particle size distribution of the toner particles is at least substantially a normal distribution.

The number-average particle diameter of toner particles can be measured and calculated using an apparatus in which a data processing computer system is connected to “Multisizer 3” (manufactured by Beckman Coulter, Inc.). In the measurement procedure, for example, 0.02 g of toner particles are wetted with 20 mL of a surfactant solution, followed by ultrasonic dispersion for 1 minute to produce a toner particle dispersion liquid in which the toner particles are dispersed. The surfactant solution is, for example, a solution obtained by 10-fold dilution of a neutral detergent including a surfactant component with pure water.

The toner particle dispersion liquid is injected into a beaker containing ISOTON II (manufactured by Beckman Coulter, Inc.) in a sample stand, with a pipette, until the concentration of the toner particles reaches 5 to 10%, and measurement is made with the measuring device count set to 25,000. It is noted that the aperture diameter of Multisizer 3 is set at 100 μm. The measurement range ranging from 1 to 30 μm is divided into 256 segments and the frequency is calculated for each segment. When MDt is a median diameter, the particle diameter at which the cumulative number percent from the larger particle-size side reaches 50% is determined as the number-average particle diameter (D50t).

MDt can be adjusted for example by the temperature and stirring condition during the production of toner particles, classification of toner particles, or mixing of classified products of toner particles.

The two-component developer satisfies the following Formula 1:

−X/8+24.75≦MDc≦−X/8+35.25 Formula 1

In Formula 1, MDc represents a volume-average particle diameter of carrier particles. X represents a proportion (%) of toner particles having a number distribution-based particle diameter of 4.5 μm or more to less than 10.0 μm and a circularity of 0.940 or less in the total of the toner particles, with the proviso that X is 10 to 50% in the Formula 1.

The MDc is a volume-average particle diameter of the carrier particles, and may be either a median diameter (D50c) or a mode diameter, when the particle size distribution of the carrier particles is at least substantially a normal distribution.

The volume-average particle diameter of the carrier particles is measured by a wet process using a laser diffraction particle size analyzer “HELOS KA” (manufactured by Japan Laser Corporation). For example, an optical system with a focal position of 200 mm is first selected, and the measuring time is set at 5 seconds. Then, carrier particles for measurement are added to 0.2% aqueous sodium dodecyl sulfate solution and dispersed for 3 minutes using an ultrasonic cleaner “US-1” (manufactured by AS ONE Corporation) to produce a sample dispersion liquid for measurement. A few drops of the sample dispersion liquid are supplied to “HELOS KA,” and measurement is initiated at a time point when a sample concentration gauge reaches a measurable range. The resultant particle size distribution is used to prepare a cumulative distribution from the smaller particle-size side for a particle size range (channel). When MDc is a median diameter, the particle diameter at which the cumulative number percent reaches 50% is determined as the volume-average particle diameter (D50c).

The MDc can be adjusted according to a method in which the particle diameter of core material particles is controlled by conditions for producing the core material particles, classification of carrier particles, mixing of classified products of carrier particles, and the like.

In the case where X ranges from 10 to 50, when the MDc is smaller than −X/8+26.75, the image quality becomes insufficient. The reason for this is considered as follows: the carrier particles are too small relative to the toner particles, which causes the toner particles to collide with the carrier particles frequently, resulting in the occurrence of toner-spent, leading to insufficient image quality. In the case where X ranges from 10 to 50, when the MDc is larger than −X/8+33.25, the image quality also becomes insufficient. The reason for this is considered as follows: the carrier particles are too large relative to the toner particles, resulting in strong impact of the carrier particles against the toner particles, which causes external additives to be embedded in the toner base particles.

X can be determined by measuring the circularity and particle diameter of toner particles concurrently using a flow type particle image analyzer mentioned below and calculating the ratio (number %) of toner particles that satisfy both the conditions of particle diameter range (4.5 μm or more to less than 10.0 μm) and of circularity range (0.940 or less) to all the toner particles. Further, X can be adjusted according to a method similar to the above-described method for adjusting MDt.

The circularity of toner particles can be measured using a flow type particle image analyzer “FPIA-3000” (manufactured by Sysmex Corporation). Specifically, the toner particles are wetted with an aqueous surfactant solution, and are dispersed via ultrasonic dispersion for 1 minute, followed by measuring with “FPIA-3000” in an HPF (high magnification imaging) mode at an appropriate concentration of the HPF detection number of 3,000 to 10,000 as a measuring condition. This method is preferred from the viewpoint of obtaining reproducible measurement values. The circularity of the toner particles is calculated according to the following Formula:

Circularity=L1/L2

where L1 represents circumference length of a circle having an area equal to the projection area of an image of a particle, and L2 represents circumference length of the projection of the particle.

The average circularity of toner particles is an arithmetic average value obtained by summing the circularities of the respective particles and dividing the sum by the total number of the measured particles.

The circularity or average circularity of toner particles can be adjusted by the degree of aging of resin particles in the production of toner particles, heat treatment of toner particles, mixing of toner particles having different circularities, and the like.

X represents the size of the toner particles and the tendency of circularity thereof. Large value of X means that the toner particles contain many relatively large particles having low circularity. Further, small value of X means that the toner particles contain many relatively small particles having high circularity.

X is preferably 20% or more, and more preferably 25% or more, from the viewpoints of enhancing the stability of image quality and suppressing the occurrence of toner-spent. Further, X is preferably 40% or less, and more preferably 35% or less, from the viewpoints of enhancing image quality and suppressing the occurrence of toner-spent.

The toner particles include toner base particles. The toner base particles contain a binder resin and a colorant.

The binder resin composes the toner base particles. As the binder resin, it is possible to use a resin that can be used for the binder resin of a toner. Either one binder resin or two or more binder resins may be used, and examples thereof include a styrene-(meth)acrylic resin, a polyester resin, and a partially modified polyester resin.

The styrene-(meth)acrylic resin has a molecular structure of a radical polymer of a compound having a radically polymerizable unsaturated bond, and can be synthesized, for example, by radical polymerization of this compound. Either one compound or two or more compounds may be employed, and examples thereof include styrene and its derivative, and (meth)acrylic acid and its derivative.

Examples of the styrene and its derivative include styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, and 3,4-dichlorostyrene.

Examples of the (meth)acrylic acid and its derivative include methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, β-hydroxyethyl acrylate, γ-aminopropyl acrylate, stearyl methacrylate, dimethylaminoethyl methacrylate, and diethylaminoethyl methacrylate.

The polyester has a molecular structure of a condensation polymerization product of a polyvalent carboxylic acid and a polyhydric alcohol, and can be synthesized, for example, by the condensation polymerization thereof.

Either one polyvalent carboxylic acid or two or more polyvalent carboxylic acids may be employed. Examples of the polyvalent carboxylic acid include aliphatic dicarboxylic acids, aromatic dicarboxylic acids, dicarboxylic acids having a double bond, trivalent or higher-valent carboxylic acids, anhydrides thereof, and lower alkyl esters thereof. A dicarboxylic acid having a double bond is preferred from the viewpoint of preventing hot offset of toner particles during fixing, because the dicarboxylic acid having a double bond is radically crosslinked via the double bond.

Examples of the aliphatic dicarboxylic acid include oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid.

Examples of the aromatic dicarboxylic acid include phthalic acid, isophthalic acid, terephthalic acid, naphthalene-2,6-dicarboxylic acid, malonic acid, and mesaconic acid.

Examples of the dicarboxylic acid having a double bond include maleic acid, fumaric acid, 3-hexenedioic acid, and 3-octenedioic acid. Among those, fumaric acid or maleic acid is preferred in terms of cost.

Examples of the trivalent or higher-valent carboxylic acid include 1,2,4-benzenetricarboxylic acid, 1,2,5-benzenetricarboxylic acid, and 1,2,4-naphthalenetricarboxylic acid.

Either one polyhydric alcohol or two or more polyhydric alcohols may be employed. Examples of the polyhydric alcohol include an aliphatic diol and a trihydric or higher-hydric alcohol. Among those, an aliphatic diol is preferred from the viewpoint of obtaining a crystalline polyester resin to be described later, and in particular a straight chain aliphatic diol having 7 to 20 carbon atoms in the main chain portion is more preferred.

When the aliphatic diol is the straight chain aliphatic diol, the crystallinity of polyester is maintained, and the melt temperature of the polyester is prevented from being lowered. Therefore, the straight chain aliphatic diol is preferred from the viewpoint of obtaining the two-component developer excellent in toner blocking resistance, image retention and low temperature fixability. Further, the straight chain aliphatic diol having 7 to 20 carbon atoms in the main chain portion is preferred from the viewpoints of restricting the melting point of a product obtained through polycondensation with an aromatic dicarboxylic acid to a low temperature, and of achieving low temperature fixation. In addition, those materials are easily available in terms of practical use. From these points of view, the straight chain aliphatic diol preferably has 7 to 14 carbon atoms in the main chain portion.

Examples of the aliphatic diol to be suitably used for the synthesis of the crystalline polyester resin include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among those, 1,8-octanediol, 1,9-nonanediol or 1,10-decanediol is preferred, in terms of easy availability.

Examples of the trihydric or higher-hydric alcohol include glycerol, trimethylolethane, trimethylolpropane and pentaerythritol.

A chain transfer agent for adjusting the molecular weight of a resin to be obtained may be added to a monomer component used for synthesizing the binder resin. Either one chain transfer agent or two or more chain transfer agents may be employed; and the chain transfer agent may be used in an amount that enables the purpose to be obtained, as long as the effects of the present embodiment are achieved. Examples of the chain transfer agent include 2-chloroethanol, mercaptans such as octyl mercaptan, dodecyl mercaptan and t-dodecyl mercaptan, and a styrene dimer.

It is preferable that the binder resin includes a crystalline resin, from the viewpoints of allowing toner particles to be easily melted to achieve energy saving during the fixation onto a recording medium. The crystalline resin is a resin having crystallinity. Examples thereof include a crystalline polyester resin and a crystalline vinyl resin. Among those, a crystalline polyester resin is preferred, and an aliphatic crystalline polyester resin is more preferred.

The crystalline polyester resin may be produced by common polyester polymerization methods in which the acid component and alcohol component are reacted. Examples of the polymerization methods include direct polycondensation and an ester exchange method, and the polymerization methods are appropriately used depending on the type of monomers, for example.

The crystalline polyester resin can be produced at a polymerization temperature of 180 to 230° C., for example. The pressure inside the reaction system is reduced as necessary, and the monomers are reacted while removing water or an alcohol generated during condensation. When a monomer is not dissolved or compatible at the reaction temperature, a solvent having a high boiling point may be added as a solubilizing agent for solubilizing the monomer. The polycondensation reaction is conducted while distilling off the solubilizing solvent. When there is a monomer with low compatibility in the copolymerization reaction, it is better to allow the monomer with low compatibility and an acid or alcohol to be subjected to polycondensation with this monomer to undergo condensation in advance, before being subjected to the polycondensation together with the main component.

The binder resin typically incorporates a colorant in a dispersed manner. Either one colorant or two or more colorants may be employed. As the colorant, a known inorganic or organic colorant used for the colorant of a color toner is used. Examples of the colorant include carbon blacks, magnetic materials, pigments and dyes.

Examples of the carbon blacks include channel black, furnace black, acetylene black, thermal black and lamp black. Examples of the magnetic materials include ferromagnetic metals such as iron, nickel, and cobalt and alloys containing these metals; and compounds of ferromagnetic metals such as ferrite and magnetite.

Examples of the pigments include C.I. Pigment Red 2, 3, 5, 7, 15, 16, 48:1, 48:3, 53:1, 57:1, 81:4, 122, 123, 139, 144, 149, 166, 177, 178, 208, 209, and 222; C.I. Pigment Orange 31, and 43; C.I. Pigment Yellow 3, 9, 14, 17, 35, 36, 65, 74, 83, 93, 94, 98, 110, 111, 138, 139, 153, 155, 180, 181, and 185; C.I. Pigment Green 7; C.I. Pigment Blue 15:3, 15:4, and 60; and a phthalocyanine pigment having a central metal of zinc, titanium, magnesium, or the like.

Examples of the dyes include C.I. Solvent Red 1, 3, 14, 17, 18, 22, 23, 49, 51, 52, 58, 63, 87, 111, 122, 127, 128, 131, 145, 146, 149, 150, 151, 152, 153, 154, 155, 156, 157, 158, 176, and 179; pyrazolotriazole azo dye; pyrazolotriazole azomethine dye; pyrazolone azo dye; pyrazolone azomethine dye; C.I. Solvent Yellow 19, 44, 77, 79, 81, 82, 93, 98, 103, 104, 112, and 162; and C.I. Solvent Blue 25, 36, 60, 70, 93, and 95.

The toner base particles may further contain components other than the binder resin and colorant as long as the effects of the present embodiment are achieved. Examples of these other components include a release agent and a charge control agent. Either one other component or two or more other components may be contained.

Examples of the release agent (wax) include hydrocarbon waxes and ester waxes. Examples of the hydrocarbon waxes include low molecular weight polyethylene wax, low molecular weight polypropylene wax, Fischer Tropsch wax, microcrystalline wax, and paraffin wax. Further, examples of the ester waxes include carnauba wax, pentaerythritol behenic acid ester, behenyl behenate, and behenyl citrate.

Examples of the charge control agent include nigrosine dyes, metal salts of naphthenic acid or higher fatty acids, alkoxylated amines, quaternary ammonium salt compounds, azo metal complexes, and salicylic acid metal salts or metal complexes thereof.

From the viewpoint of properly controlling the particle diameter and circularity of the toner particles, the process for producing the toner base particles is preferably a build-up type toner production process such as emulsion polymerization and coagulation method, for example, a method in which colorant particles and binder resin particles dispersed in an aqueous medium are aggregated and fused to produce toner base particles, or suspension polymerization, rather than a pulverization method, and the emulsion polymerization and coagulation method is more preferred. The process for producing the toner base particles by means of the emulsion polymerization and coagulation method includes, for example, the following steps of:

(a) forming binder resin particles from a binder resin to prepare a binder resin particle dispersion liquid in which the binder resin particles are dispersed in an aqueous medium;

(b) aggregating the binder resin in the aqueous medium to obtain resin particles which become toner base particles (aggregation/fusing step);

(c) cooling; and

(d) filtration, washing, and drying.

It is preferable that the toner particles further include an external additive, from the viewpoint of controlling the flow ability and chargeability of the toner particles. Either one external additive or two or more external additives may be employed. Examples of the external additive include silica particles, titania particles, alumina particles, zirconia particles, zinc oxide particles, chromium oxide particles, cerium oxide particles, antimony oxide particles, tungsten oxide particles, tin oxide particles, tellurium oxide particles, manganese oxide particles, and boron oxide particles.

The external additive more preferably includes silica particles produced by a sol-gel method. The silica particles produced by a sol-gel method are preferred, from the viewpoint of suppressing the dispersion of adhesive strength of the external additive to the toner base particles, because the silica particles produced by a sol-gel method have a feature of narrow particle diameter distribution.

Further, the silica particles preferably have a number-average primary particle diameter of 70 to 200 nm. Silica particles having a number-average primary particle diameter within the above range are larger than other external additives, and therefore have a role of a spacer in the two-component developer. Accordingly, such silica particles are preferred from the viewpoint of preventing other smaller external additives from being embedded in the toner base particles when the two-component developer is stirred in a developing machine, and also from the viewpoint of preventing toner base particles from fusing together.

The number-average primary particle diameter of the external additive can be determined, for example, by image processing of an image photographed with a transmission electron microscope, and can be adjusted, for example, by classification, mixing of classified products, and the like.

The surface of the external additive is preferably subjected to hydrophobic treatment. For performing the hydrophobic treatment, a known surface-treating agent is used. Either one surface-treating agent or two or more surface-treating agents may be used, and examples thereof include a silane coupling agent, a silicone oil, a titanate coupling agent, an aluminate coupling agent, a fatty acid, a fatty acid metal salt, an esterified product thereof, and a rosin acid.

Examples of the silane coupling agent include dimethylmethoxysilane, hexamethyldisilazane (HMDS), methyltrimethoxysilane, isobutyltrimethoxysilane and decyltrimethoxysilane. Examples of the silicone oil include a cyclic compound and a linear or branched organosiloxane; and more specific examples thereof include an organosiloxane oligomer, octamethylcyclotetrasiloxane, decamethylcyclopentasiloxane, tetramethylcyclotetrasiloxane, and tetravinyltetramethylcyclotetrasiloxane.

Further, examples of the silicone oil include a highly reactive silicone oil having at least a modified terminal, in which a modification group is introduced into a side chain, one terminal, both terminals, one terminal or both terminals of a side chain, or the like. The type of the modification group may be either one or two or more, and examples thereof include alkoxy, carboxyl, carbinol, a higher fatty acid-modified silicone oil, phenol, epoxy, methacryl and amino.

The addition amount of the external additive is preferably 0.1 to 10.0 mass %, and more preferably 1.0 to 3.0 mass % to the total amount of toner particles.

The carrier particles are composed of magnetic materials. Examples of the carrier particles include coated type carrier particles having a core material particle made of the magnetic material and a coating material layer that coats the surface of the core material particle, and resin-dispersed type carrier particles in which fine powders of the magnetic material are dispersed in the resin. It is preferable that the carrier particles are the coated type carrier particles, from the viewpoint of suppressing the adhesion of carrier particles to a photoconductor.

The core material particles are composed of a magnetic material, for example, a material that uses a magnetic field to magnetize an area in that direction. Either one magnetic material or two or more magnetic materials may be employed, and examples thereof include metals exhibiting ferromagnetic properties, such as iron, nickel and cobalt, alloys or compounds including these metals, and alloys exhibiting ferromagnetic properties upon heat treatment.

Examples of the metals exhibiting ferromagnetic properties or compounds including these metals include iron, a ferrite represented by Formula (a):

Mo·Fe₂O₃, Formula (a)

and a magnetite represented by Formula (b):

MFe₂O₄ Formula (b)

where M in Formulas (a) and (b) represents one or more monovalent or divalent metals selected from the group consisting of Mn, Fe, Ni, Co, Cu, Mg, Zn, Cd and Li.

Further, examples of the alloys exhibiting ferromagnetic properties upon heat treatment include Heusler's alloys such as manganese-copper-aluminum and manganese-copper-tin, and chromium dioxide.

The core material particles are preferably various ferrites, because the specific gravity of the coated type carrier particles is smaller than the specific gravity of a metal composing the core material particles to thereby enable the impact of stirring inside the developing machine to be smaller.

Either one coating material or two or more coating materials may be employed. As the coating material, a known resin to be utilized for the coating of core material particles of carrier particles can be used. It is preferable that the coating material is a resin having a cycloalkyl group, from the viewpoints of reducing the moisture adsorption properties of carrier particles and of enhancing the adhesion of the coating layer to the core material particle. Examples of the cycloalklyl group include cyclohexyl group, cyclopentyl group, cyclopropyl group, cyclobutyl group, cycloheptyl group, cyclooctyl group, cyclononyl group, and cyclodecyl group. Among those, cyclohexyl group or cyclopentyl group is preferred; and cyclohexyl group is more preferred from the viewpoint of the adhesion between the coating layer and the ferrite particle.

The weight-average molecular weight Mw of the resin having a cycloalkyl group is, for example, 10,000 to 800,000, and more preferably 100,000 to 750,000. The cycloalkyl group content in the resin is, for example, 10 mass % to 90 mass %. The cycloalkyl group content in the resin can be determined using a known analytical instrument such as pyrolysis-gas chromatography/mass spectrometry (P-GC/MS) or ¹H-NMR, for example.

The two-component developer can be produced by mixing suitable amounts of the toner particles and the carrier particles. Examples of a mixer to be used for this mixing include Nauter mixer, a W-cone mixer and a V-shape mixer.

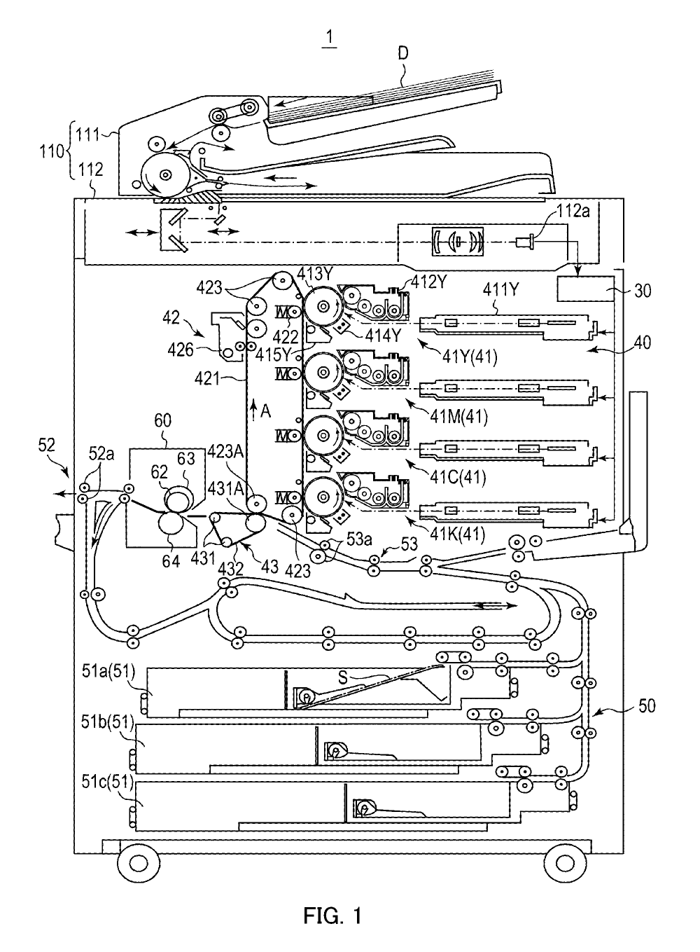

The two-component developer can be applied to a typical image forming method by the electrophotographic process. For example, the two-component developer is housed in an image forming apparatus illustrated in FIG. 1, and is used for forming a toner image on a recording medium.

Image forming apparatus 1 illustrated in FIG. 1 includes image reading section 110, image processing section 30, image forming section 40, sheet conveying section 50, and fixing device 60.

Image forming section 40 has image forming units 41Y, 41M, 41C and 41K that form images with the respective color toners of Y (yellow), M (magenta), C (cyan) and K (black). All these units have the same configuration except toner to be housed therein, and therefore signs representing colors may be hereinafter abbreviated at times. Image forming section 40 further has intermediate transfer unit 42 and secondary transfer unit 43. These units correspond to a transfer device.

Image forming unit 41 has exposure device 411, developing device 412, photoconductor drum 413, charging device 414, and drum cleaning device 415. Photoconductor drum 413 is, for example, a negative charge type organic photoconductor. The surface of photoconductor drum 413 has photoconductive properties. Photoconductor drum 413 corresponds to a photoconductor. Charging device 414 is, for example, a corona charger. Charging device 414 may be a contact charging device that charges photoconductor drum 413 by contacting a contact charging member such as a charging roller, a charging brush or a charging blade with photoconductor drum 413. Exposure device 411 includes, for example, a semiconductor laser as a light source, and a light deflection device (polygon motor) that emits laser light in accordance with an image to be formed toward photoconductor drum 413.

Developing device 412 is a developing device in a two-component developing system. Developing device 412 includes, for example, a developing container that houses the two-component developer, a developing roller (magnetic roller) disposed rotatably at the opening of the developing container, a partition that parts the inside of the developing container such that the two-component developer can be in fluid communication, a conveyance roller for conveying the two-component developer on the opening side in the developing container toward the developing roller, and a stirring roller for stirring the two-component developer inside the developing container. The developing container contains the two-component developer according to the present embodiment.

Intermediate transfer unit 42 has intermediate transfer belt 421, a primary transfer roller 422 that presses intermediate transfer belt 421 into close contact with photoconductor drum 413, a plurality of support rollers 423 including backup roller 423A, and belt cleaning device 426. Intermediate transfer belt 421 is stretched in a loop manner by the plurality of support rollers 423. The rotation of at least one driving roller of the plurality of support rollers 423 allows intermediate transfer belt 421 to run at a constant speed in the direction of arrow A.

Secondary transfer unit 43 has endless secondary transfer belt 432, and a plurality of support rollers 431 including secondary transfer roller 431A. Secondary transfer belt 432 is stretched in a loop manner by secondary transfer roller 431A and support rollers 431.

Fixing device 60 has, for example, fixing roller 62, endless heat-generating belt 63 for covering the outer peripheral surface of fixing roller 62 and for heating and melting a toner composing a toner image on sheet S, and pressure roller 64 that presses sheet S against fixing roller 62 and heat-generating belt 63. Sheet S corresponds to a recording medium.

Image forming apparatus 1 further has image reading section 110, image processing section 30 and sheet conveying section 50. Image reading section 110 has sheet feeder 111 and scanner 112. Sheet conveying section 50 has sheet feeding section 51, sheet discharging section 52, and conveying path section 53. Sheet S (standard sheet, special sheet) identified based on basis weight or size is housed for each preset type in three sheet feeding tray units 51a to 51c which constitute sheet feeding section 51. Conveying path section 53 has a plurality of pairs of conveying rollers such as a pair of resist rollers 53a.

The formation of an image by image forming apparatus 1 will be described. Scanner 112 optically scans and reads manuscript D on contact glass. Light reflected from manuscript D is read by CCD sensor 112a to be input as image data. The input image data is subjected to a predetermined image processing in image processing section 30, and sent to exposure device 411.

Photoconductor drum 413 rotates at a constant peripheral speed. Charging device 414 charges the surface of photoconductor drum 413 uniformly to a negative polarity. In exposure device 411, a polygon mirror of a polygon motor rotates at high speed, and laser light corresponding to the input image data of each color component travels along the axial direction of photoconductor drum 413 to be emitted onto the outer peripheral surface of photoconductor drum 413 along the axial direction. Thus, an electrostatic latent image is formed on the surface of photoconductor drum 413.

In developing device 412, the conveyance and stirring of the two-component developer inside the developing container allow toner particles to be charged, and the two-component developer is conveyed to the developing roller to form a magnetic brush on the surface of the developing roller. The charged toner particles electrostatically adhere to an electrostatic latent image portion on photoconductor drum 413 from the magnetic brush. Thus, the electrostatic latent image on the surface of photoconductor drum 413 is visualized, and a toner image in accordance with the electrostatic latent image is formed on the surface of photoconductor drum 413.

As described above, the two-component developer has toner particles whose number-average particle diameter ranges from 3.5 to 5.0 μm, and satisfies the Formula 1. Therefore, the two-component developer contains relatively small carrier particles when the toner particles are relatively large and have relatively low circularity, and contains relatively large carrier particles when the toner particles are relatively small and have relatively high circularity. Accordingly, the toner particles are prevented from easily colliding with the carrier particles, and the large impact of the carrier particles against the toner particles is suppressed in a moderate manner. As a result, in developing device 412, the two-component developer sufficiently flows, and the toner particles are charged evenly and sufficiently, so that the toner particles allow the electrostatic latent image to be developed faithfully even in fine detail.

The toner image on the surface of photoconductor drum 413 is transferred to intermediate transfer belt 421 by intermediate transfer unit 42. Untransferred toner remaining on the surface of photoconductor drum 413 after the transfer is removed by drum cleaning device 415 having a drum cleaning blade which slidably contacts the surface of photoconductor drum 413.

Primary transfer roller 422 presses intermediate transfer belt 421 into close contact with photoconductor drum 413, to thereby allow photoconductor drum 413 and intermediate transfer belt 421 to form a primary transfer nip for each photoconductor drum. At the primary transfer nip, toner images of the respective colors are transferred sequentially in a superimposed manner on intermediate transfer belt 421.

On the other hand, secondary transfer roller 431A is pressed into close contact with backup roller 423A with intermediate transfer belt 421 and secondary transfer belt 432 interposed therebetween. Thus, a secondary transfer nip is formed by intermediate transfer belt 421 and secondary transfer belt 432. Sheet S passes through the secondary transfer nip. Sheet S is conveyed to the secondary transfer nip by sheet conveying section 50. A resist roller section provided with pairs of resist rollers 53a corrects the inclination of sheet S and adjusts the timing of the conveyance.

When sheet S is conveyed to the secondary transfer nip, transfer bias is applied to secondary transfer roller 431A. The application of this transfer bias allows a toner image carried by intermediate transfer belt 421 to be transferred to sheet S. Sheet S on which the toner image is transferred is conveyed toward fixing device 60 by secondary transfer belt 432.

Fixing device 60 uses heat-generating belt 63 and pressure roller 64 to form a fixing nip and to heat and pressurize conveyed sheet S at the fixing nip portion. Thus, the toner image is fixed onto sheet S. Since the toner particles are relatively small, a portion on the surface of sheet S, on which an image is to be formed is covered with less amount of toner particles, and the toner particles are more likely to be melted. Therefore, in the above-described toner image fixation, thermal energy (electric energy) required for fixation is further reduced compared to the case of fixing a toner image of conventional-sized toner particles. Sheet S on which the toner image is fixed is discharged out of the apparatus by sheet discharging section 52 provided with sheet discharging rollers 52a. Thus, a high-quality image without grainy feeling is formed.

It is noted that untransferred toner remaining on the surface of intermediate transfer belt 421 after the secondary transfer is removed by belt cleaning device 426 having a belt cleaning blade which slidably contacts the surface of intermediate transfer belt 421.

As is obvious from the above description, the two-component developer contains the toner particles and the carrier particles, with the number-average particle diameter of the toner particles MDt ranging from 3.5 to 5.0 μm, and satisfies the Formula 1. Therefore, it is possible to maintain high flow ability of the two-component developer and suppress the occurrence of toner-spent even when smaller toner particles are used.

It is even more effective for the two-component developer to satisfy the following Formula 2:

−X/8+26.75≦MDc≦−X/8+33.25 Formula 2

(with the proviso that 15≦X≦40 in Formula 2)

from the viewpoints of developing images with stable quality for a long period of time in image formation, and of suppressing the occurrence of toner-spent.

It is even more effective for the toner base particles of the toner particles to be toner base particles obtained by aggregating and fusing colorant particles and binder resin particles dispersed in an aqueous medium, from the viewpoint of properly controlling the particle diameter and circularity of the toner particles.

It is even more effective for the binder resin to include a crystalline resin, from the viewpoint of achieving energy saving during the fixation.

It is even more effective for the external additive of the toner particles to include silica particles produced by a sol-gel method and for the silica particles to have a number-average primary particle diameter of 70 to 200 nm, from the viewpoints of suppressing the dispersion of adhesive strength of the external additive to the toner base particles, and of preventing a smaller external additive from being embedded in the toner base particles.

As has been described above, the two-component developer is capable of maintaining high flow ability even though using smaller toner particles, and of suppressing the occurrence of toner-spent. As a result, by using the two-component developer for an image forming method by the electrophotographic process, it becomes possible to form a high-quality image stably for a long period of time.

### Examples

The present invention will be described further specifically with reference to the following Examples and Comparative Examples. The present invention is not construed to be limited by the following Examples.

[Preparation of Colorant Microparticle Dispersion Liquid]

11.5 parts by mass of sodium n-dodecylsulfate was added to 160 parts by mass of ion-exchanged water, followed by stirring, and the dissolved solution was stirred, while 24.5 parts by mass of copper phthalocyanine was gradually added into the solution. Next, a dispersion treatment was performed using a stirring apparatus “CLEARMIX W-motion CLM-0.8” (manufactured by M Technique Co.) to prepare colorant microparticle dispersion liquid (A1) in which the volume-based median diameter of the copper phthalocyanine particles in the solution was 126 nm.

It is noted that the volume-based median diameter of the colorant microparticle dispersion liquid (A1) was determined using an electrophoretic light scattering photometer “ELS-800” (manufactured by Otsuka Electronics Co., Ltd.).

[Production of Crystalline Polyester Resin]

A three-necked flask was loaded with 300 g of 1,9-nonanediol, 250 g of dodecanedioic acid, and a catalyst Ti(OBu)₄ (0.014 mass % to a carboxylic acid monomer) to prepare a liquid mixture, and then the pressure of the air inside the container was reduced by a pressure-reducing operation. Further, a nitrogen gas was introduced into the three-necked flask to allow the inside of the flask to have an inert atmosphere, and the liquid mixture was refluxed at 180° C. for 6 hours under mechanical stirring. Thereafter, an unreacted monomer component was removed by distillation under reduced pressure, and the temperature was gradually elevated to 220° C., followed by stirring for 12 hours. When the mixture became viscous, the mixture was cooled to obtain a crystalline polyester resin (B1). The weight-average molecular weight (Mw) of the resultant crystalline polyester resin (B1) was 19,500. Further, the melting point of the crystalline polyester resin (B1) was 75° C.

Mw of the crystalline polyester resin (B1) is determined according to the following procedures: tetrahydrofuran (THF) is flowed as a carrier solvent at a flow rate of 0.2 mL/min while maintaining a column temperature at 40° C. using an apparatus “HLC-8220” (manufactured by Tosoh Corporation) and a column “TSK guard column+TSK gel Super HZM-M 3 series” (manufactured by Tosoh Corporation)”; 10 μL of a sample solution is injected into the apparatus; refractive index detector (RI detector) is used for detection; and a molecular weight distribution of the measurement sample is calculated using a calibration curve measured using monodisperse polystyrene standard particles.

The sample solution is prepared by dissolving the measurement sample in THF in a dissolving condition of performing 5-minute treatment using an ultrasonic disperser at room temperature so as to have a concentration of 1 mg/ml, followed by filtration with a membrane filter having a pore size of 0.2 μm. Further, the calibration curve is prepared by measuring at least about 10 standard polystyrene samples. As the standard polystyrene sample, standard polystyrene samples (manufactured by Pressure Chemical Company) having molecular weights of 6×10², 2.1×10³, 4×10³, 1.75×10⁴, 5.1×10⁴, 1.1×10⁵, 3.9×10⁵, 8.6×10⁵, 2×10⁶, and 4.48×10⁶ are used.

The melting point of the crystalline polyester resin (B1) is determined according to the following procedures: measurement is performed using a differential scanning calorimeter “Diamond DSC” (manufactured by PerkinElmer Co., Ltd.), and 3.0 mg of the sample is sealed in an aluminum-made pan and then placed in a sample holder, with an empty aluminum-made pan being set as a reference, according to measuring conditions (temperature elevating/cooling conditions) which undergoes, sequentially, a first heating process in which the temperature of the crystalline polyester resin (B1) is elevated from 0 to 200° C. at an elevating rate of 10° C./min, a cooling process in which the temperature of the crystalline polyester resin (B1) is cooled from 200 to 0° C. at a cooling rate of 10° C./min, and a second heating process in which the temperature of the crystalline polyester resin (B1) is elevated from 0 to 200° C. at an elevating rate of 10° C./min; and the melting point of the crystalline polyester resin (B1) is determined as an endothermic peak top temperature derived from the crystalline polyester in the first heating process in the DSC curve obtained by this measurement.

[Preparation of Dispersion Liquid of Resin Particles (C1) (First Step Polymerization)]

4 g of polyoxyethylene (2) sodium dodecyl ether sulfate and 3,000 g of ion-exchanged water were charged into a 5 L reaction vessel equipped with a stirrer, a temperature sensor, a condenser, and a nitrogen inlet device, and the temperature of the resultant liquid mixture was elevated to 80° C. while stirring the liquid mixture at a stirring speed of 230 rpm under a nitrogen stream. After the temperature elevation, a solution of 10 g of potassium persulfate dissolved in 200 g of ion-exchanged water was added to the liquid mixture, and the liquid temperature of the liquid mixture was lowered to 75° C. A monomer liquid mixture having the composition of:

| | | |
|---|---|---|
| styrene | 568 | g; |
| n-butyl acrylate | 164 | g; and |
| methacrylic acid | 68 | g |

was added dropwise to the liquid mixture over 1 hour. Subsequently, the monomer was polymerized by heating the liquid mixture at 75° C. for 2 hours under stirring to prepare a dispersion liquid of resin particles (C1).

[Preparation of Dispersion Liquid of Resin Particles (C2) (Second Step Polymerization)]

A solution of 2 g of polyoxyethylene (2) sodium dodecyl ether sulfate dissolved in 3,000 g of ion-exchanged water was charged into a 5 L reaction vessel equipped with a stirrer, a temperature sensor, a condenser, and a nitrogen inlet device, and the resultant liquid mixture was heated to 80° C.

On the other hand, a solution of a monomer having the composition of:

| resin particles (C1) | 42 g (in terms of solid content); | |
|---|---|---|
| wax | 70 | g; |
| crystalline polyester resin (B1) | 70 | g; |
| styrene | 195 | g; |
| n-butyl acrylate | 91 | g; |
| methacrylic acid | 20 | g; and |
| n-octylmercaptan | 3 | g |

dissolved at 80° C. was prepared. Thereafter, the solution was added to the liquid mixture, and mixing and dispersion were performed for 1 hour using a mechanical disperser “CLEARMIX” (manufactured by M technique Co., Ltd.) having a circulating path to prepare a dispersion liquid containing emulsified particles (oil droplets). Next, an initiator solution in which 5 g of potassium persulfate was dissolved in 100 g of ion-exchanged water was prepared, and added to the dispersion liquid. The resultant dispersion liquid was heated at 80° C. over 1 hour under stirring for polymerization of the monomer to prepare a dispersion liquid of resin particles (C2).

It is noted that the wax is “HNP-0190” (manufactured by Nippon Seiro Co., Ltd.).

[Preparation of Dispersion Liquid of Fine Resin Particles for Core (C3) (Third Step Polymerization)]

A solution of 10 g of potassium persulfate dissolved in 200 g of ion-exchanged water was further added to the dispersion liquid of the resin particles (C2), and the resultant dispersion liquid was maintained at 80° C. A monomer liquid mixture having the composition of:

| | | |
|---|---|---|
| styrene | 298 | g; |
| n-butyl acrylate | 137 | g; |
| n-stearyl acrylate | 50 | g; |
| methacrylic acid | 64 | g; and |
| n-octylmercaptan | 6 | g |

was added dropwise to the dispersion liquid over 1 hour. After completion of the dropwise addition, the resultant dispersion liquid was heated over 2 hours under stirring for polymerization of the monomer, and then the dispersion liquid was cooled to 28° C. to prepare a dispersion liquid of fine resin particles for core (C3).

[Preparation of Dispersion Liquid of Fine Resin Particles for Shell (D1)]

A reaction vessel equipped with a stirrer, a temperature sensor, a condenser, and a nitrogen inlet device was charged with a surfactant solution in which 2.0 g of polyoxyethylene sodium dodecyl ether sulfate was dissolved in 3,000 g of ion-exchanged water, and the temperature of the solution was elevated to 80° C. under stirring at a stirring speed of 230 rpm under a nitrogen stream. To this solution was added an initiator solution in which 10 g of potassium persulfate was dissolved in 200 g of ion-exchanged water, and a monomer liquid mixture having the composition of:

| | | |
|---|---|---|
| styrene | 564 | g; |
| n-butyl acrylate | 140 | g; |
| methacrylic acid | 96 | g; and |
| n-octylmercaptan | 12 | g |

was added dropwise to the solution over 3 hours. After the dropwise addition, the resultant liquid mixture was heated at 80° C. over 1 hour under stirring for polymerization of the monomer to prepare a dispersion liquid of fine resin particles for shell (D1).

[Production of Core Shell Particles (Aggregation and Fusing Step)]

A 5 L reaction vessel equipped with a stirrer, a temperature sensor, a condenser, and a nitrogen inlet device was charged with 360 g (in terms of solid content) of the dispersion liquid of fine resin particles for core (C3), 1,100 g of ion-exchanged water and 50 g of the colorant microparticle dispersion liquid (A1). The temperature of the resultant dispersion liquid was adjusted to 30° C., and subsequently a 5N aqueous sodium hydroxide solution was added to the dispersion liquid to adjust the pH of the dispersion liquid to 10. Next, an aqueous solution in which 60 g of magnesium chloride was dissolved in 60 g of ion-exchanged water was added to the dispersion liquid at 30° C. over 10 minutes under stirring. After the addition, the dispersion liquid was held at 30° C. for 3 minutes, and then the temperature was started to be elevated. The temperature of the dispersion liquid was elevated to 85° C. over 60 minutes, and the particle growth reaction was continued while holding the temperature of the dispersion liquid at 85° C. to prepare a dispersion liquid of precore particles (1).

In this state, the particle diameter of associated precore particles (1) was measured using “Coulter Multisizer 3” (manufactured by Beckman Coulter, Inc.). At the time when the number-based median diameter of the precore particles (1) was 4.1 μm, an aqueous solution in which 40 g of sodium chloride was dissolved in 160 g of ion-exchanged water was added to the dispersion liquid to stop the growth of the precore particles (1). Further, the dispersion liquid was stirred at a liquid temperature of 80° C. over 1 hour as an aging step, thereby advancing fusion among the precore particles (1), to form core particles (1).

Next, 80 g (in terms of solid content) of the fine resin particles for shell (D1) were added, and the stirring was continued for 1 hour at 80° C. The fine resin particles for shell (D1) were fused on the surface of the core particle (1) for formation of a shell layer, to obtain resin particles (1). Here, an aqueous solution in which 150 g of sodium chloride was dissolved in 600 g of ion-exchanged water was added to the resultant dispersion liquid, and an aging treatment was performed at a liquid temperature of 80° C. At the time when the average circularity of the resin particles (1) was 0.950, the dispersion liquid was cooled to 30° C. The cooled core shell particles (1) had a number-based median diameter of 4.2 μm and an average circularity of 0.950.

It is noted that the average circularity of the core shell particles (1) was determined as an average value of circularities obtained using a flow type particle image analyzer “FPIA-3000” according to the above-described measuring conditions. Further, the number-based median diameter of the core shell particles (1) was measured using “Coulter Multisizer 3” similarly to the measurement of the core particles (1).

[Production of Toner Base Particles (Washing and Drying Step)]

The dispersion liquid of the core shell particles (1) generated in the aggregation and fusing steps was subjected to solid-liquid separation using a centrifugal separator to form a wet cake of core shell particles. The wet cake was washed with ion-exchanged water at 35° C. until the electric conductivity of the filtrate reached 5 μS/cm using the centrifugal separator, then moved to “Flash Jet Dryer” (manufactured by Seishin Enterprise Co., Ltd.), and dried until the moisture amount was 0.8 mass % to produce toner base particles 1. The proportion X of spherical toner base fine particles in the toner base particles 1 was 10.0%.

X (%) of the toner base particles 1 was determined using “FPIA-3000”. It is noted that the spherical toner base fine particles are particles having a number distribution-based particle diameter of 4.5 μm or more to less than 10.0 μm and a circularity of 0.940 or less.

[Production of Toner Base Particles 2 to 5]

Toner base particles 2 to 5 were produced similarly to the toner base particles 1, except that the temperatures of the dispersion liquids of the resin particles were lowered to 30° C. at the time when the average circularities of the resin particles were 0.938, 0.925, 0.956, and 0.922, respectively. The values of X for the toner base particles 2, 3, 4, and 5 were, respectively, 30.0%, 50.0%, 8.0%, and 52.0%.

[Production of Toner Base Particles 6 to 8]

Toner base particles 6 were produced similarly to the toner base particles 1, except that the growth of the precore particles was stopped at the time when the number-based median diameter of the precore particles was 3.4 μm. The core shell particles of the toner base particles 6 (core shell particles (6)) had a number-based median diameter of 3.5 μm and an average circularity of 0.945, and the value of X for the toner base particles 6 was 10.0%.

Toner base particles 7 and 8 were produced similarly to the toner base particles 6, except that the temperatures of the dispersion liquids of the resin particles were lowered to 30° C. at the time when the average circularities of the resin particles were 0.932 and 0.921, respectively. The values of X for the toner base particles 7 and 8 were, respectively, 30.0% and 50.0%.

[Production of Toner Base Particles 9 to 11]

Toner base particles 9 were produced similarly to the toner base particles 1, except that the growth of the precore particles was stopped at the time when the number-based median diameter of the precore particles was 4.9 μm. The core shell particles of the toner base particles 9 (core shell particles (9)) had a number-based median diameter of 5.0 μm and an average circularity of 0.965, and the value of X for the toner base particles 9 was 10.0%.

Toner base particles 10 and 11 were produced similarly to the toner base particles 9, except that the temperatures of the dispersion liquids of the resin particles were lowered to 30° C. at the time when the average circularities of the resin particles were 0.950 and 0.938, respectively. The values of X for the toner base particles 10 and 11 were, respectively, 30.0% and 50.0%.

[Production of Toner Base Particles 12 and 13]

Toner base particles 12 were produced similarly to the toner base particles 1, except that the growth of the precore particles was stopped at the time when the number-based median diameter of the precore particles was 3.3 μm and that the temperature of the dispersion liquid of the resin particles was lowered to 30° C. at the time when the average circularity of the resin particles was 0.928. The number-based median diameter of the core shell particles of the toner base particles 12 (core shell particles (12)) was 3.4 μm, and the value of X for the toner base particles 12 was 30.0%.

Toner base particles 13 were produced similarly to the toner base particles 1, except that the growth of the precore particles was stopped at the time when the number-based median diameter of the precore particles was 5.0 μm and that the temperature of the dispersion liquid of the resin particles was lowered to 30° C. at the time when the average circularity of the resin particles was 0.952. The number-based median diameter of the core shell particles of the toner base particles 13 (core shell particles (13)) was 5.1 μm, and the value of X for the toner base particles 13 was 30.0%.

[Production of Toner Particles 1 (External Additive Treatment Step)]

The following powders in the following amounts:

| | | |
|---|---|---|
| sol-gel silica | 2.0 | mass %; |
| hydrophobic silica | 2.5 | mass %; and |
| hydrophobic titanium oxide | 0.5 | mass % |

were added to the toner base particles 1, and the mixture was added to a Henschel mixer, model “FM20C/1” (manufactured by Nippon coke & Engineering Co., Ltd.), followed by stirring for 15 minutes at a blade edge peripheral speed of 40 m/s which had been set by adjusting the revolution speed of stirring blades, to produce toner particles 1.

The “sol-gel silica” is treated with hexamethyldisilazane (HMDS), and has a hydrophobicity of 72% and a number-average primary particle diameter of 130 nm. In addition, the “hydrophobic silica” is treated with HMDS, and has a hydrophobicity of 72% and a number-average primary particle diameter of 40 nm. Further, the “hydrophobic titanium oxide” is treated with HMDS, and has a hydrophobicity of 55% and a number-average primary particle diameter of 20 nm. Furthermore, the addition amounts of the powders are addition amounts of the respective powders in the toner particles 1.

The temperature of the mixed powders at the time when the powders were externally added to and mixed with the toner particles 1 was set at 40° C.±1° C. The temperature inside the Henschel mixer was controlled by flowing cooled water at a flow rate of 5 L/min to the jacket of the Henschel mixer when the temperature was 41° C., and by flowing cooled water so that the flow rate of the cooled water was 1 L/min when the temperature was 39° C.

It is noted that a catalogue value may be employed for the number-average primary particle diameter of the powders, but alternatively it can also be determined by the processing of an image photographed by a transmission electron microscope. For example, the toner particles 1 were photographed at a magnification of 10,000 and at an accelerating voltage of 80 kV using “JEM-2000FX” (manufactured by JEOL Ltd.), and the photographic image was captured by a scanner and subjected to binarization processing in terms of the external additive particles using an image processing analyzer “LUZEX AP” (manufactured by Nireco Corporation, “LUZEX” is a registered trademark of this company) to calculate Feret's diameters of 100 particles in the horizontal direction, so that the number-average primary particle diameter of the powders can be determined as an average value thereof “Feret's diameter in the horizontal direction” is the length of a side parallel to a circumscribed rectangle in the longitudinal direction, when the image of the external additive particles is subjected to binarization processing.

[Production of Toner Particles 2 to 13]

Toner particles 2 to 13 were obtained similarly to the toner particles 1, except that the toner base particles 2 to 13 were used respectively in place of the toner base particles 1.

It is noted that the average circularities of the toner particles 1 to 13 were the same respectively as the average circularities of the core shell particles in the toner particles (core shell particles (1) to (13)). Further, the number distribution-based median diameters D50t of the toner particles 1 to 13 were the same respectively as the median diameters of the core shell particles in the toner particles (core shell particles (1) to (13)).

[Production of Resin for Coating Core Material (Coating Material 1)]

To an aqueous solution of 0.3 mass % of sodium benzenesulfonate were added cyclohexyl methacrylate and methyl methacrylate at a molar ratio of 1:1, followed by addition of potassium persulfate in an amount equivalent to 0.5 mass % of the total amount of monomers to perform emulsion polymerization, and resin particles in the resultant dispersion liquid were dried by spray-drying of the dispersion liquid to produce coating material 1 which is a resin for coating core material. The resultant coating material 1 had a weight-average molecular weight Mw of 500,000. Mw of coating material 1 was determined by Gel Permeation Chromatography (GPC) similarly to the above-described crystalline polyester resin (B1).

[Production of Carrier Particles 1]

Mn—Mg ferrite particles having a volume-average diameter of 15 μm were prepared as core material particles. 100 parts by mass of the ferrite particles and 4.5 parts by mass of coating material 1 were loaded into a high-speed stirring mixer with horizontal stirring blades, and mixed and stirred at 22° C. for 15 minutes under the condition that the peripheral speed of the horizontal revolving blade was 8 m/sec. Thereafter, mixing was performed at 120° C. for 50 minutes, and the surface of the core material particles was coated with coating material 1 by the action of mechanical impact (mechanochemical method) to prepare carrier particles 1. The volume distribution-based median diameter of the carrier particles 1 (D50c) was 18.0 μm.

The D50c and Y of the carrier particles 1 were determined based on the above-described method using a laser diffraction particle size analyzer “HELOS KA” (manufactured by Japan Laser Corporation).

[Production of Carrier Particles 2 to 14]

Carrier particles 2 to 14 were produced similarly to the carrier particles 1, except that the loading amount of the coating material 1 was changed. The value of D50c of the carrier particles 2 was 19.0 μm.

Further, the values of D50c of the carrier particles 3, 4, 5, 6, 7, 8, 9, and 10 were, respectively, 21.0 μm, 22.0 μm, 23.5 μm, 24.0 μm, 27.0 μm, 28.5 μm, 29.0 μm, and 30.0 μm.

Furthermore, the values of D50c of the carrier particles 11, 12, 13, and 14 were, respectively, 31.0 μm, 32.0 μm, 34.0 μm, and 35.0 μm.

[Production of Two-Component Developer 1]

Toner particles 6 and carrier particles 5 were mixed such that the toner particle content (toner concentration) in a two-component developer was 7 mass % to produce two-component developer 1. V-type mixer was used for the mixing. Mixing time was set at 30 minutes. Further, two-component developers 2 to 19 and C1 to C10 were produced similarly to the two-component developer 1, except that the combination of the toner particles and the carrier particles was changed to combinations listed in Tables 1 and 2 shown below. The combinations of toner particles and carrier particles in the two-component developers 1 to 19 and the physical property values thereof are shown in Table 1, and the combinations of toner particles and carrier particles in the two-component developers C1 to C10 and the physical property values thereof are shown in Table 2.

TABLE 1

| | Two-Component | Toner Particles | | | Carrier Particles | |
|---|---|---|---|---|---|---|
| Ex. | Developer | | D50t | X | | D50c |
| No. | No. | No. | (μm) | (%) | No. | (μm) |
| 1 | 1 | 6 | 3.5 | 10.0 | 5 | 23.5 |
| 2 | 2 | 6 | 3.5 | 10.0 | 13 | 34.0 |
| 3 | 3 | 7 | 3.5 | 30.0 | 7 | 27.0 |
| 4 | 4 | 8 | 3.5 | 50.0 | 2 | 19.0 |
| 5 | 5 | 8 | 3.5 | 50.0 | 9 | 29.0 |
| 6 | 6 | 1 | 4.2 | 10.0 | 5 | 23.5 |
| 7 | 7 | 1 | 4.2 | 10.0 | 8 | 28.5 |
| 8 | 8 | 1 | 4.2 | 10.0 | 13 | 34.0 |
| 9 | 9 | 2 | 4.2 | 30.0 | 3 | 21.0 |
| 10 | 10 | 2 | 4.2 | 30.0 | 7 | 27.0 |
| 11 | 11 | 2 | 4.2 | 30.0 | 11 | 31.0 |
| 12 | 12 | 3 | 4.2 | 50.0 | 2 | 19.0 |
| 13 | 13 | 3 | 4.2 | 50.0 | 6 | 24.0 |
| 14 | 14 | 3 | 4.2 | 50.0 | 9 | 29.0 |
| 15 | 15 | 9 | 5.0 | 10.0 | 5 | 23.5 |
| 16 | 16 | 9 | 5.0 | 10.0 | 13 | 34.0 |
| 17 | 17 | 10 | 5.0 | 30.0 | 7 | 27.0 |
| 18 | 18 | 11 | 5.0 | 50.0 | 2 | 19.0 |
| 19 | 19 | 11 | 5.0 | 50.0 | 9 | 29.0 |

TABLE 2

| | Two-Component | Toner Particles | | | Carrier Particles | |
|---|---|---|---|---|---|---|
| Comp. Ex. | Developer | | D50t | X | | D50c |
| No. | No. | No. | (μm) | (%) | No. | (μm) |
| 1 | C1 | 12 | 3.4 | 30.0 | 7 | 27.0 |
| 2 | C2 | 4 | 4.2 | 8.0 | 8 | 28.5 |
| 3 | C3 | 1 | 4.2 | 10.0 | 4 | 22.0 |
| 4 | C4 | 1 | 4.2 | 10.0 | 14 | 35.0 |
| 5 | C5 | 2 | 4.2 | 30.0 | 2 | 19.0 |
| 6 | C6 | 2 | 4.2 | 30.0 | 12 | 32.0 |
| 7 | C7 | 3 | 4.2 | 50.0 | 1 | 18.0 |
| 8 | C8 | 3 | 4.2 | 50.0 | 10 | 30.0 |
| 9 | C9 | 5 | 4.2 | 52.0 | 5 | 23.5 |
| 10 | C10 | 13 | 5.1 | 30.0 | 7 | 27.0 |

[Evaluation]

As an evaluation apparatus, a commercially available digital full-color multifunctional machine “bizhub PRO C6500” (manufactured by Konica Minolta, Inc., “bizhub” is a registered trademark of this company) was used. Each of the two-component developers 1 to 19 and C1 to C10 was loaded into the apparatus, and printing (durable printing) was performed on 100,000 sheets of A4 size wood-free paper (65 g/m²) on which a belt-shaped solid image is formed as a test image at a coverage rate of 5% under the environment of high temperature and high humidity (30° C., 80% RH).

(1) Image Quality (Graininess, GI Value)

At the initial printing stage and after the durable printing on 100,000 sheets, images with gradation patterns at 32 gradient scales were output using the respective two-component developers 1 to 19 and C1 to C10. As for the evaluation of the graininess in the images, the gradation patterns were read by CCD, and the obtained read value was subjected to Fourier transform processing taking account of MTF (Modulation Transfer Function) correction, followed by measurement of Graininess Index (GI) value adapted to human spectral luminous efficiency to determine the maximum GI value. Smaller GI value is better, and smaller GI value indicates less grainy feeling of images. It is noted that the GI value is a value set forth in Journal of the Imaging Society of Japan, 39 (2), pp. 84-93 (2000). According to the following evaluation criteria, the graininess of the gradation patterns in the images at the initial printing stage and after the durable printing was evaluated.

The images with gradation patterns output at the initial printing stage were judged, based on the maximum GI value (GIi) in these images, according to the following criteria:

A: GIi is less than 0.170

B: GIi is 0.170 or more to less than 0.180

C: GIi is 0.180 or more

Further, the images with gradation patterns output after the durable printing were judged, based on the difference between the GIi and the maximum GI value in the gradation patterns after the durable printing GIa (ΔGI (GIa−GIi)), according to the following criteria:

A: ΔGI is 0 or more to less than 0.010

B: ΔGI is 0.010 or more to less than 0.020

C: ΔGI is 0.020 or more

(2) Toner-Spent

After the durable printing, the two-component developer used was taken out from the evaluation apparatus, and the two-component developer was washed with an aqueous surfactant solution to collect carrier particles from the two-component developer. 3 g of the carrier particles were dissolved in 100 mL of methyl ethyl ketone, and the transmittance of light at a wavelength of 630 nm in the resultant solution was determined to judge the toner-spent according to the following criteria:

A: Transmittance is 95% or more

B: Transmittance is less than 95% and 90% or more

C: Transmittance is less than 90%

Evaluation results of the two-component developers 1 to 19 are shown in Table 3, and evaluation results of the two-component developers C1 to C10 are shown in Table 4.

TABLE 3

| | Two- | Graininess | | | | | | |
|---|---|---|---|---|---|---|---|---|
| | Component | Initial Stage | | After Durable Printing | | | Toner-Spent | |
| Ex. | Developer | GIi | | GIa | ΔGI | | Transmittance | |
| No. | No. | (—) | Judgment | (—) | (—) | Judgment | (%) | Judgment |
| 1 | 1 | 0.150 | A | 0.168 | 0.018 | B | 90.2 | B |
| 2 | 2 | 0.155 | A | 0.165 | 0.010 | B | 93.4 | B |
| 3 | 3 | 0.155 | A | 0.165 | 0.010 | B | 90.9 | B |
| 4 | 4 | 0.164 | A | 0.178 | 0.014 | B | 93.2 | B |
| 5 | 5 | 0.171 | B | 0.184 | 0.013 | B | 95.1 | A |
| 6 | 6 | 0.152 | A | 0.166 | 0.014 | B | 91.2 | B |
| 7 | 7 | 0.154 | A | 0.164 | 0.010 | B | 91.9 | B |
| 8 | 8 | 0.158 | A | 0.167 | 0.009 | A | 95.1 | A |
| 9 | 9 | 0.155 | A | 0.159 | 0.004 | A | 92.2 | B |
| 10 | 10 | 0.162 | A | 0.168 | 0.006 | A | 96.4 | A |
| 11 | 11 | 0.165 | A | 0.179 | 0.014 | B | 96.7 | A |
| 12 | 12 | 0.171 | B | 0.177 | 0.006 | A | 92.1 | B |
| 13 | 13 | 0.172 | B | 0.180 | 0.008 | A | 94.3 | B |
| 14 | 14 | 0.173 | B | 0.182 | 0.009 | A | 96.8 | A |
| 15 | 15 | 0.163 | A | 0.174 | 0.011 | B | 92.2 | B |
| 16 | 16 | 0.166 | A | 0.178 | 0.012 | B | 93.9 | B |
| 17 | 17 | 0.169 | A | 0.184 | 0.015 | B | 94.5 | B |
| 18 | 18 | 0.174 | B | 0.183 | 0.009 | A | 94.5 | B |
| 19 | 19 | 0.178 | B | 0.185 | 0.007 | A | 94.4 | B |

TABLE 4

| | Two- | Graininess | | | | | | |
|---|---|---|---|---|---|---|---|---|
| Comp. | Component | Initial Stage | | After Durable Printing | | | Toner-Spent | |
| Ex. | Developer | GIi | | GIa | ΔGI | | Transmittance | |
| No. | No. | (—) | Judgment | (—) | (—) | Judgment | (%) | Judgment |
| 1 | C1 | 0.152 | A | 0.168 | 0.016 | B | 87.8 | C |
| 2 | C2 | 0.153 | A | 0.170 | 0.017 | B | 89.1 | C |
| 3 | C3 | 0.152 | A | 0.171 | 0.019 | B | 87.3 | C |
| 4 | C4 | 0.164 | A | 0.194 | 0.030 | C | 94.7 | B |
| 5 | C5 | 0.156 | A | 0.172 | 0.016 | B | 86.9 | C |
| 6 | C6 | 0.168 | A | 0.189 | 0.021 | C | 93.8 | B |
| 7 | C7 | 0.166 | A | 0.183 | 0.017 | B | 88.8 | C |
| 8 | C8 | 0.176 | B | 0.203 | 0.027 | C | 93.3 | B |
| 9 | C9 | 0.171 | B | 0.211 | 0.040 | C | 94.8 | B |
| 10 | C10 | 0.171 | B | 0.192 | 0.021 | C | 94.4 | B |

As is obvious from Tables 1 to 4, all the two-component developers 1 to 19 can suppress the grainy feeling of images sufficiently, and can also suppress the occurrence of the toner-spent sufficiently. In contrast, all the two-component developers C1 to C10 are insufficient in at least one of the suppression of the grainy feeling of images and the suppression of the occurrence of the toner-spent.

Further, as is obvious from, for example, comparison between the two-component developers 6 to 14 and the two-component developers C3 to C9, it can be understood that, when X ranges from 10 to 50%, the MDt is 4.2 μm, and −X/8+24.75≦MDc≦−X/8+35.25 (Formula 1) is satisfied, the grainy feeling of images is sufficiently suppressed, and the occurrence of the toner-spent is sufficiently suppressed.

According to, for example, comparison among the two-component developers 1 to 5, the two-component developers 6, 8, 10, 12 and 14, and the two-component developers 15 to 19; comparison between the two-component developer 3 and the two-component developer C1; comparison between the two-component developer 17 and the two-component developer C10; comparison between the two-component developer 7 and the two-component developer C2; and comparison between the two-component developers 13 and the two-component developer C9, it can be understood that, when X ranges from 10 to 50%, the MDt ranges from 3.5 to 5.0 μm, and −X/8+24.75≦MDc≦−X/8+35.25 (Formula 1) is satisfied, the grainy feeling of images is sufficiently suppressed, and the occurrence of the toner-spent is sufficiently suppressed.

According to, for example, comparison among the two-component developers 9 to 11, it can be understood that, when X ranges from 15 to 40%, the MDt ranges from 3.8 to 4.8 μm, and −X/8+26.75≦MDc≦−X/8+33.25 (Formula 2) is satisfied, both the grainy feeling of images and the occurrence of the toner-spent are sufficiently suppressed.

On the other hand, according to the two-component developers C3, C5 and C7, for example, when MDc is smaller than the range specified by the Formula (1), the occurrence of the toner-spent tends to be insufficiently suppressed. The reason for this is considered as follows: the smaller carrier particles cause collision between the carrier particles and the toner particles to occur frequently, thereby also causing toner-spent to occur frequently.

According to the two-component developers C4, C6 and C8, for example, when MDc is larger than the range specified by the Formula (1), the stability of images is lowered in association with image-forming operation for a long period of time, so that the graininess in the images tends to be insufficient. The reason for this is considered as follows: stronger impact of the carrier particles against the toner particles due to the larger carrier particles cause external additives of the toner particles to be embedded in toner base particles, thus lowering the flow ability and chargeability of the toner particles, also leading to the lowering of image quality.

According to the two-component developer C1, for example, when D50t is too small, the occurrence of the toner-spent tends to be insufficiently suppressed. The reason for this is considered as follows: collision of the toner particles with the carrier particles occurs frequently, which also causes toner-spent to occur frequently. Further, according to the two-component developer C2, for example, when X is too small, the occurrence of the toner-spent tends to be insufficiently suppressed. The reason for this is considered as follows: the percentage of toner particles having high circularity becomes relatively large, which increases the flow ability of the toner particles, thus causing the collision of the toner particles with the carrier particles to occur frequently, thus also causing toner-spent to occur frequently.

According to the two-component developer C9, for example, when X is too large, the graininess in the images tends to be insufficient in association with image-forming operation for a long period of time. The reason for this is considered as follows: the percentage of toner particles having low circularity becomes relatively large, resulting in the lowering of image quality. Further, according to the two-component developer C10, for example, when D50t is too large, the graininess in the images tends to be insufficient in association with image-forming operation for a long period of time. The reason for this is considered as follows: the percentage of large toner particles becomes relatively large, resulting in the lowering of image quality.

### INDUSTRIAL APPLICABILITY

According to the present invention, it is possible to form a high-quality image with toner particles having small particle diameter, and to provide a two-component developer which suppresses the occurrence of toner-spent. Therefore, according to the present invention, higher performance and more energy saving can be expected in electrophotographic image forming apparatuses, with further spread of the image forming apparatuses being expected.

What is claimed is:

1. A two-component developer for developing an electrostatic latent image, comprising toner particles and carrier particles, wherein
a number-average particle diameter of the toner particles ranges from 3.5 to 5.0 μm, and
the two-component developer satisfies the following Formula 1:
−X/8+24.75≦MDc≦−X/8+35.25 Formula 1
where MDc represents a volume-average particle diameter (μm) of the carrier particles, and X represents a proportion (%) of toner particles having a number distribution-based particle diameter of 4.5 μm or more to less than 10.0 μm and a circularity of 0.940 or less in the total of the toner particles, with the proviso that 10≦X≦50 in Formula 1.

2. The two-component developer according to claim 1, wherein
the number-average particle diameter of the toner particles ranges from 3.8 to 4.8 μm, and
the two-component developer satisfies the following Formula 2:
−X/8+26.75≦MDc≦−X/8+33.25 Formula 2,
with the proviso that 15≦X≦40 in Formula 2.

3. The two-component developer according to claim 1, wherein
the toner particles include toner base particles, and
the toner base particles are toner base particles obtained by aggregating and fusing colorant particles and particles of a binder resin dispersed in an aqueous medium.

4. The two-component developer according to claim 1, wherein the binder resin includes a crystalline resin.

5. The two-component developer according to claim 1, wherein
the toner particles further include an external additive,
the external additive includes silica particles produced by a sol-gel method, and
a number-average primary particle diameter of the silica particles ranges from 70 to 200 nm.
